(19) United States
(12) Patent Application Publication
(10) Pub. No.: US 2016/0361721 A1
(43) Pub. Date: Dec. 15, 2016

(54) MEDICATION COLLECTION SYSTEMS AND RELATED METHODS

(71) Applicant: Eric Agricola, Clarksville, OH (US)

(72) Inventor: Eric Agricola, Clarksville, OH (US)

(21) Appl. No.: 15/178,625

(22) Filed: Jun. 10, 2016

Related U.S. Application Data
(60) Provisional application No. 62/174,149, filed on Jun. 11, 2015.

(51) Int. Cl. B02C 19/00; B02C 18/22

(52) U.S. Cl. CPC B02C 19/0075; B02C 18/2216

(57) ABSTRACT

A medication collection system includes a body, a collection receptacle, a door, a drop box assembly, a scannable indicia, and at least one securing mechanism. The body defines an interior cavity and an exterior. The body includes at least a top panel, a front panel, a back panel, and left and right side panels. The collection receptacle is disposed within the interior cavity. The door allows for access to the collection receptacle. The drop box assembly is attached to the body and disposed above the collection receptacle. The drop box assembly has a door moveable between an open position and a closed position. The scannable indicia is disposed on the exterior of the body and configured to be scanned by a user. At least one securing mechanism is attached to the body to prevent the body from being moved. The medication collection system may include a shredding assembly.

### CROSS REFERENCE TO RELATED APPLICATION

This application claims the filing benefit of U.S. Provisional Patent Application Ser. No. 62/174,149, filed on Jun. 11, 2015 (pending), the entire disclosure of which is hereby incorporated by reference herein.

### TECHNICAL FIELD

This disclosure generally relates to medication collection, and more particularly, to medication collection systems and methods of collecting medications.

### BACKGROUND

Federal regulations require that long term care facilities securely collect and destroy unused medications including controlled substances. Currently, most long term care facilities rely on their administrative staff or Directors of Nursing and nurses to collect the unused medications and store them in a secured location until a representative from the pharmacy collects unused medications for disposal. In most cases the unused medications, including controlled substances, are stored in a locked and secured room where the staff has limited access. This practice poses security and compliance challenges for the facilities, which typically have limited secured storage areas and employees may have potential access to the secured storage areas.

Therefore, it would be desirable to have a medication collection system into which items (such as unused patient medications) may be deposited, which is easy to use, secure from unauthorized access, and complies with federal regulations.

### SUMMARY

In accordance with one exemplary embodiment, a medication collection system includes a body, a collection receptacle, a door, a drop box assembly, a scannable indicia, and at least one securing mechanism. The body defines an interior cavity and an exterior. The body includes at least a top panel, a front panel, a back panel disposed opposite the front panel, and left and right side panels disposed opposite one another and adjacent the front and back panels. The collection receptacle is disposed within the interior cavity. The door is hingably attached to one of the panels of the body for allowing access to the collection receptacle. The drop box assembly is attached to the body and disposed above the collection receptacle. The drop box assembly has a door moveable between an open position and a closed position. The drop box assembly is configured to receive items when the door is in the open position and drop the items into the collection receptacle when the door is moved to the closed position. The scannable indicia is disposed on the exterior of the body and is configured to be scanned by a user. At least one securing mechanism is attached to the body and is configured to be attached to a non-movable structure to prevent the body from being moved.

In accordance with another exemplary embodiment, a medication collection system includes a body, a collection receptacle, a door, a drop box assembly, a shredding assembly, at least one securing mechanism, at least one sensor, a display screen, and first and second slideable tracks. The body defines an interior cavity and an exterior. The body includes at least a top panel, a front panel, a back panel disposed opposite the front panel, and left and right side panels disposed opposite one another and adjacent the front and back panels. The collection receptacle is disposed within the interior cavity. The door is hingably attached to one of the panels of the body for allowing access to the collection receptacle. The drop box assembly is attached to the body and is disposed above the collection receptacle. The drop box assembly has a door moveable between an open position and a closed position. The drop box assembly is configured to receive items when the door is in the open position and direct the items into the collection receptacle when the door is moved to the closed position. The shredding assembly is disposed adjacent the top panel of the body and is configured to shred items and then drop the shredded items into the collection receptacle. At least one securing mechanism is attached to the body and is configured to be attached to a non-movable structure to prevent the body from being moved. At least one sensor is configured to indicate when the collection receptacle needs to be emptied. The display screen is in communication with the at least one sensor and is configured to display a message when the collection receptacle needs to be emptied. The first slideable track is attachable to the left side panel and the collection receptacle. The second slideable track is attachable to the right side panel and the collection receptacle. The first and second slideable tracks enable the collection receptacle to slidably move out of the interior cavity when the door is opened.

In accordance with yet another aspect of the present invention, a method of operating a medication collection system is described. The medication collection system includes a body defining an interior cavity and an exterior, a collection receptacle, a removable liner, and a door. The body includes at least a top panel, a front panel, a back panel disposed opposite the front panel, and left and right side panels disposed opposite one another and adjacent the front and back panels. The collection receptacle is slidably disposed within the interior cavity. The removable liner is placed within the collection receptacle to collect items. The door is hingably attached to one of the panels of the body allowing for access to the collection receptacle. The method includes sensing when the removable liner needs to be replaced using at least one sensor. The method also includes unlocking and then opening the door to access to the interior cavity. The method also includes sliding out the collection receptacle. The method also includes removing the removable liner from the collection receptacle. The method also includes inserting a replacement removable liner within the collection receptacle. The method also includes locking the door to prevent unauthorized access to the interior cavity.

In accordance with yet another aspect of the present invention, a method of disposing items into a medication collection system is described. The medication collection system includes a body having an exterior and an interior cavity and a drop box assembly attached to the body and having a door moveable between an open position and a closed position. The method includes logging the items to be inserted into the drop box assembly. The method also includes scanning a scannable indicia disposed on the exterior of the body. The method also includes inserting the items when the door is in the open position. The method also includes moving the door to the closed position to transfer the inserted items into the interior cavity.

These and other objects and advantages of the disclosed system and method will become more readily apparent through the following detailed description taken in conjunction with the drawings herein.

### BRIEF DESCRIPTION OF THE DRAWINGS

FIG. 1 is a perspective view of a medication collection system including a shredding assembly and a drop box assembly in accordance with an exemplary embodiment.

FIG. 2 is a perspective view of the medication collection system of FIG. 1, with the right side wall hidden using broken lines.

FIG. 3 is a right side elevational view of the medication collection system of FIG. 2 and the right side wall being hidden.

FIG. 4A is a right side elevational view of a partial portion of the medication collection system of FIG. 3, with the drop box assembly shown in the open position and the right side wall being hidden.

FIG. 4B is a right side elevational view similar to FIG. 4A, with the drop box assembly shown in the closed position and the right side wall being hidden.

FIG. 5A is a perspective view of a partial portion of the medication collection system of FIG. 1, with the shedding assembly partially removed.

FIG. 5B is a perspective view similar to FIG. 5A, as the shredding assembly is being removed.

FIG. 6 is a perspective view of the medication collection system including a drop box assembly according to another exemplary embodiment.

FIG. 7 is a perspective view of the medication collection system of FIG. 6, with the right side wall hidden using broken lines.

FIG. 8 is a perspective view of the medication collection system including a shredding assembly according to yet another exemplary embodiment.

FIG. 9 is a perspective view of the medication collection system of FIG. 8, with the right side wall hidden using broken lines.

FIG. 10 is a flowchart of a method of operating a medication collection system according to an exemplary embodiment.

### DETAILED DESCRIPTION

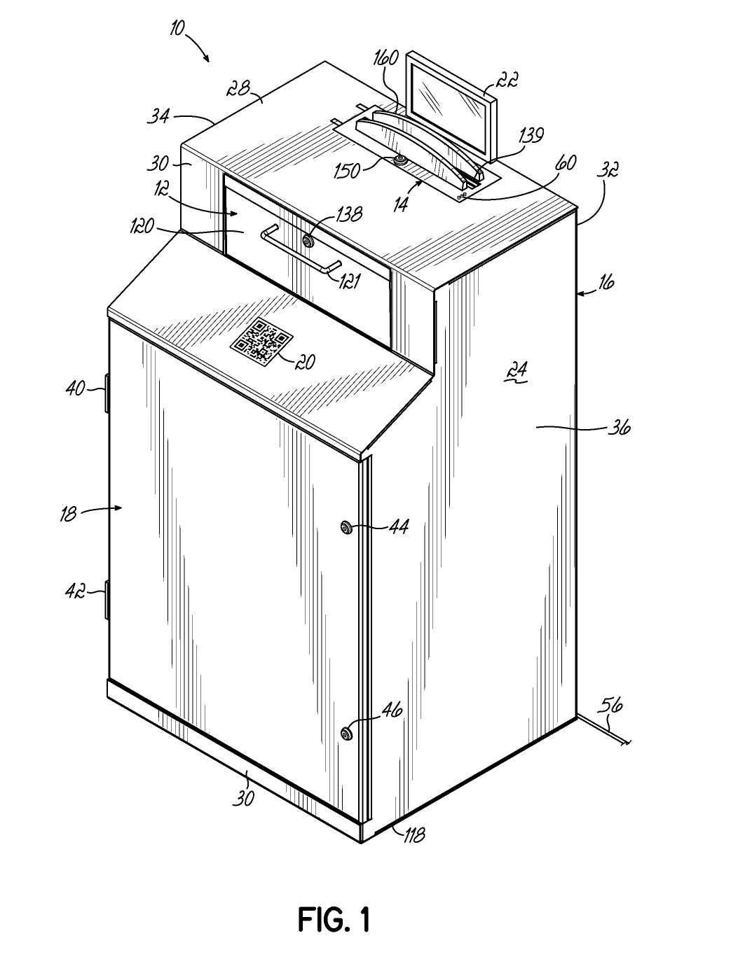

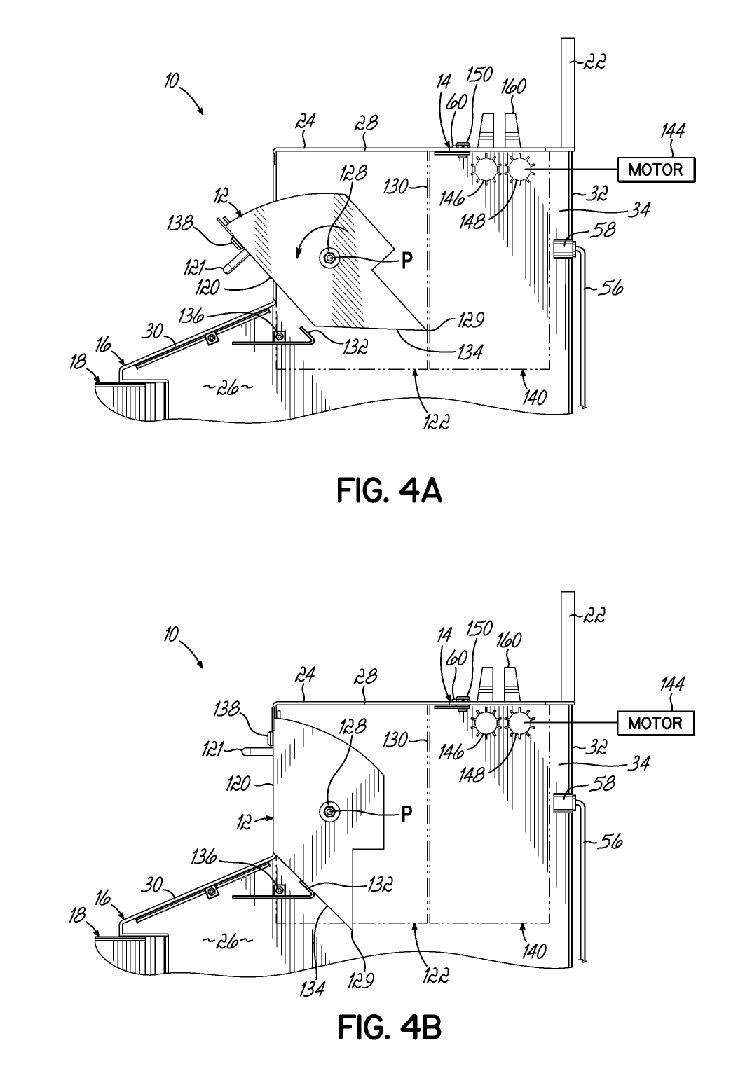

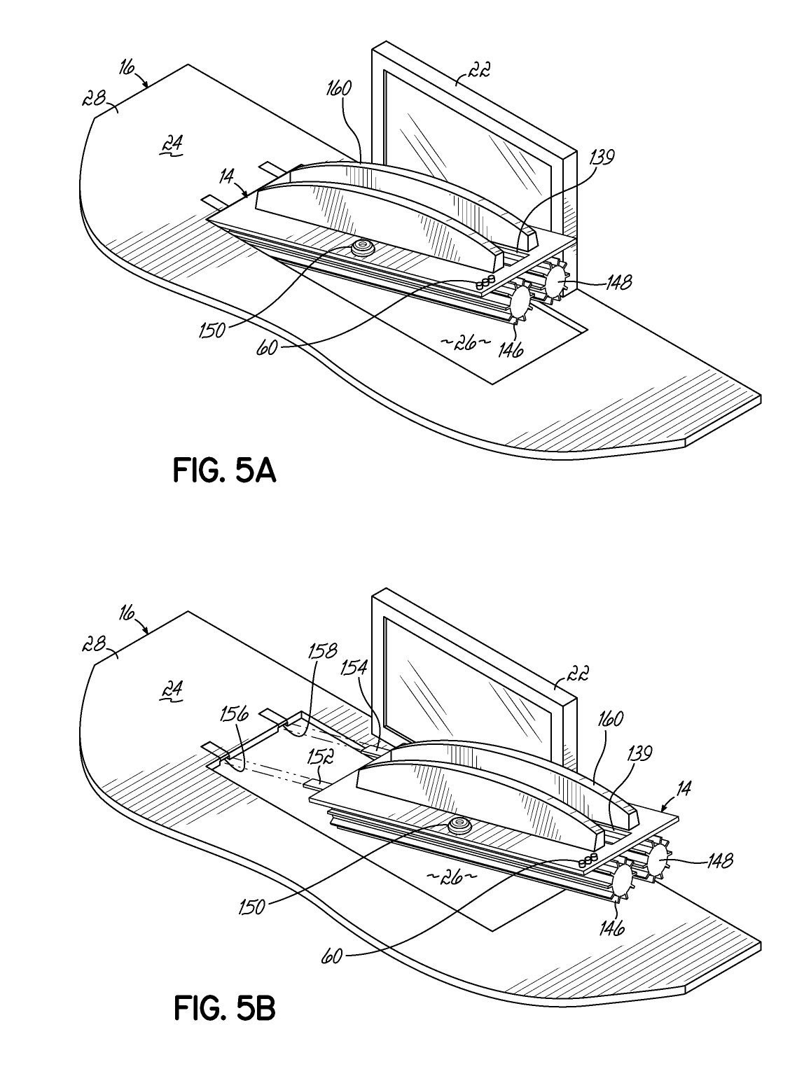

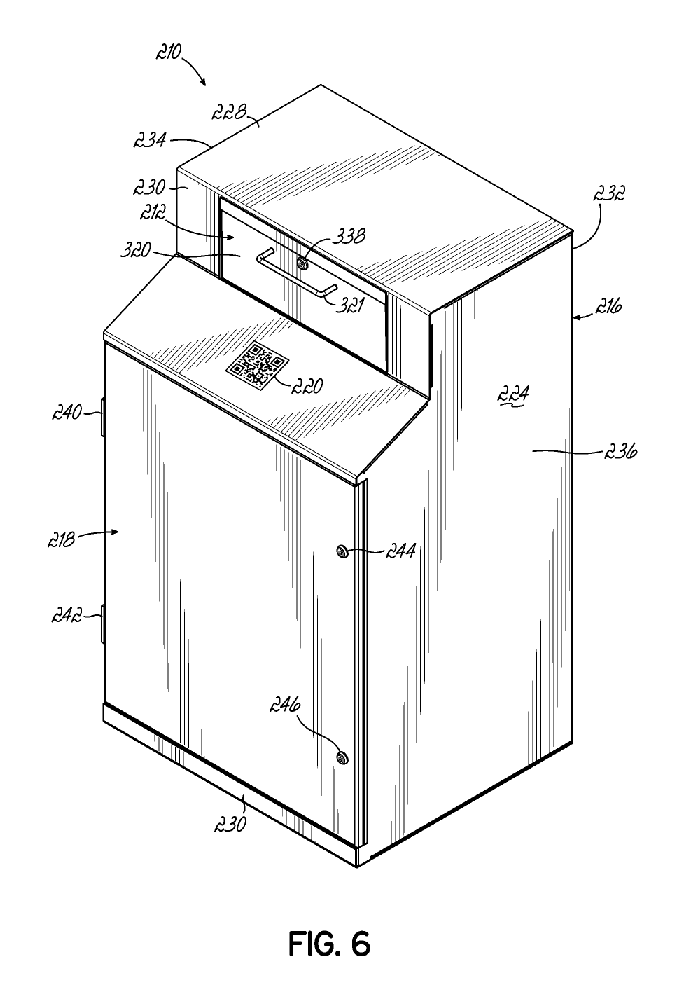

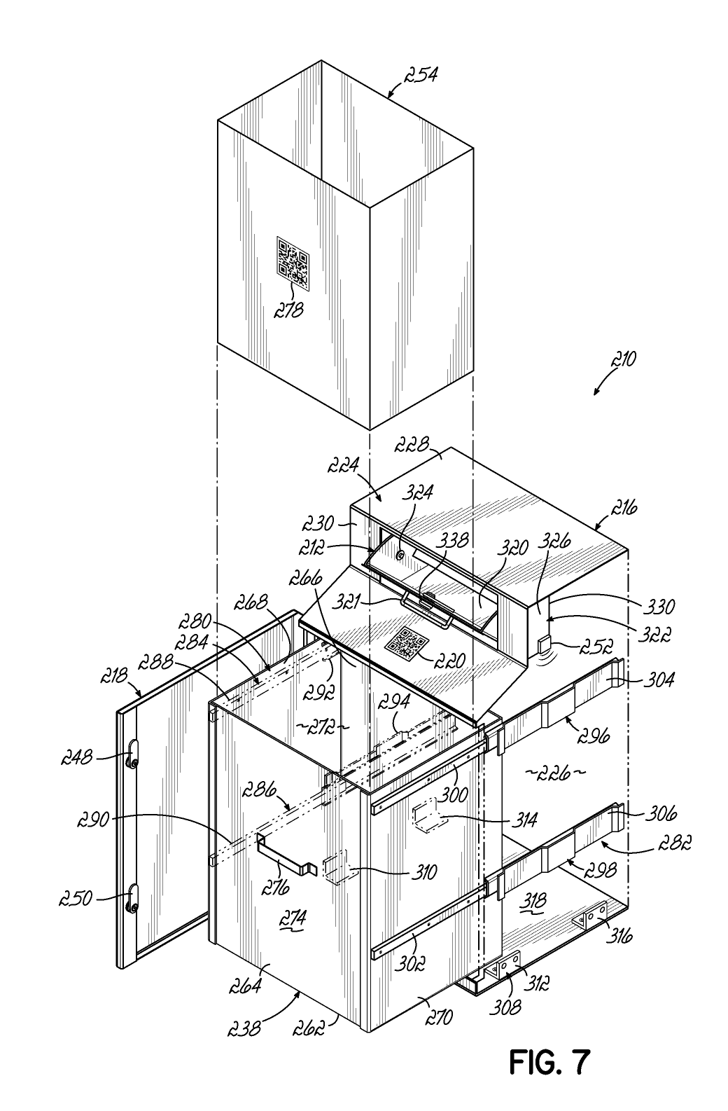

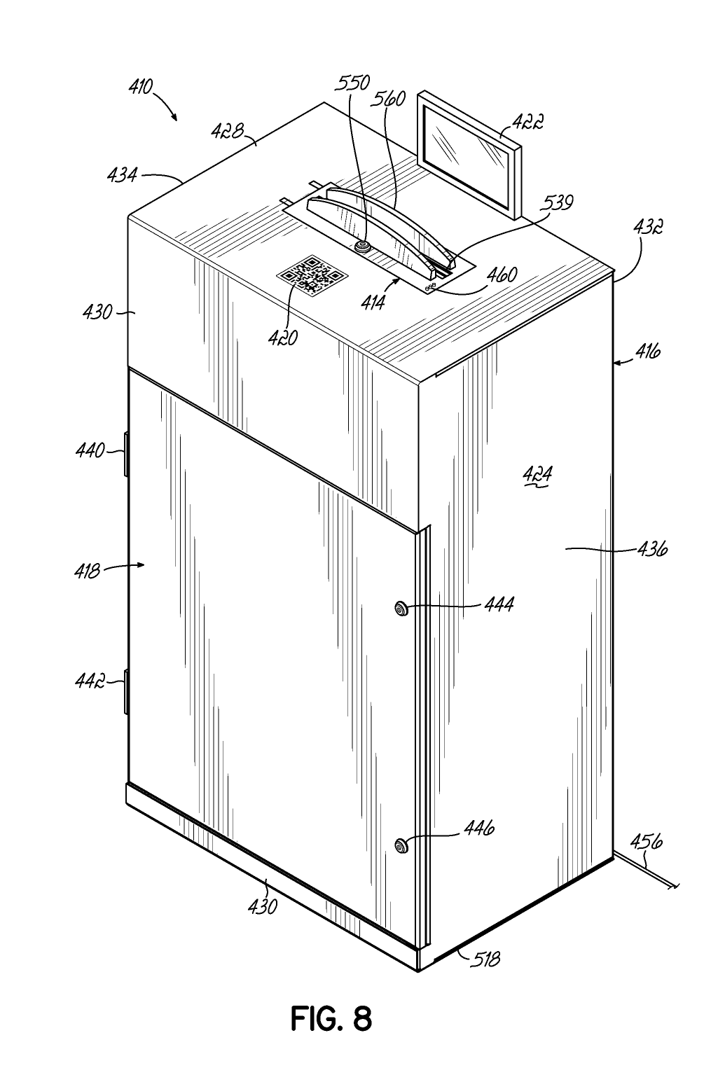

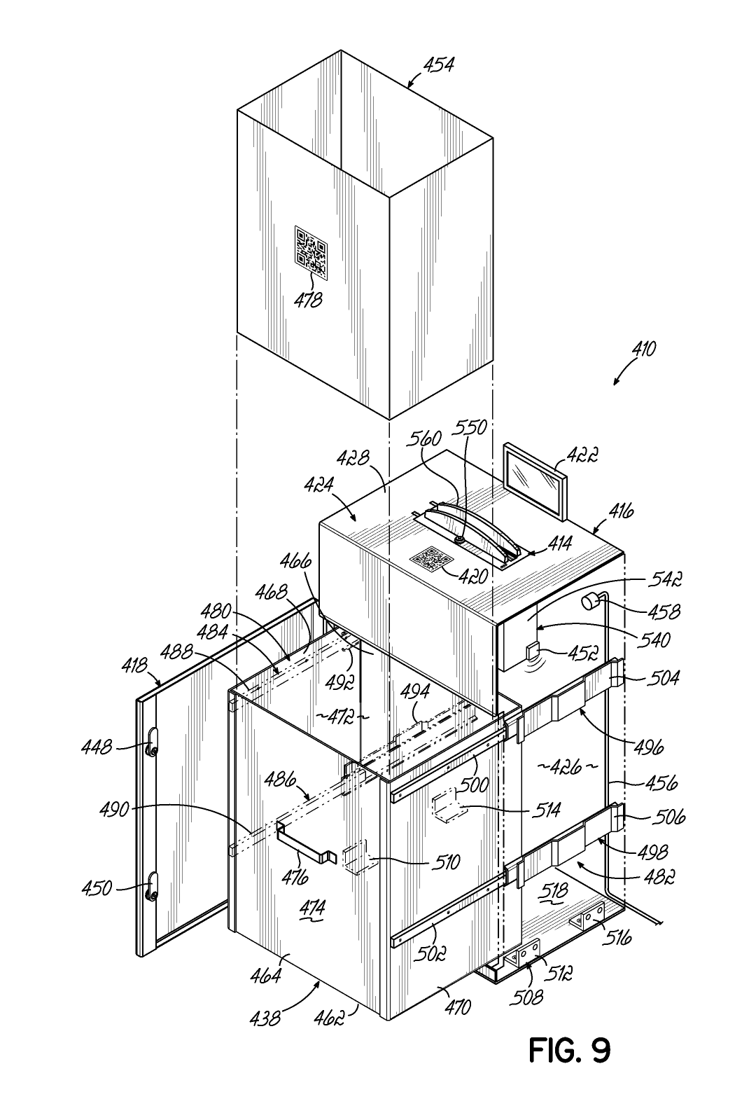

FIGS. 1-9 show medication collection systems 10, 210, 410 according to various exemplary embodiments. Specifically, FIGS. 1-5B show the medication collection system 10 as including both a drop box assembly 12 and a shredding assembly 14, FIGS. 6 and 7 show the medication collection system 210 as including a drop box assembly 212 without a shredding assembly, and FIGS. 8 and 9 show the medication collection system 410 as including a shredding assembly 414 without a drop box assembly. The function, benefits, and structural features of each of these embodiments are described in turn below in connection with the respective Figures. Additionally, the drop box assembly 12, 212 will be discussed in greater detail with respect to FIGS. 4A and 4B, while the shredding assembly 14, 414 will be discussed in greater detail with respect to FIGS. 5A and 5B.

As shown in FIGS. 1-5B, the medication collection system 10 includes a body 16, a door 18, a drop box assembly 12, a shredding assembly 14, a scannable indicia 20, and a display screen 22. The body 16 provides for secure storage of items (including medications and related documents) deposited by a user until a collector collects the deposited items from the medication collection system 10, 210, 410. As used herein, a “user” is intended to refer to any individual that deposits items (including medication and related documents) into the medication collection system 10, 210, 410, either through the drop box assembly 12, 212 or through the shredding assembly 14, 414. The user may include, but is not limited to, a hospital employee, a long term care facility employee, a pharmacist, a doctor, a patient, or any other person having undesired medications or related documents in need of secure collection. Further as used herein, a “collector” is intended to refer to any individual entrusted to collect the deposited items contained within the medication collection system 10, 210, 410. The collector may include, but is not limited to, a pharmacist, a pharmacy staff member, an individual employed by a collection and/or disposal company, a hospital employee, a long term care facility employee, a nurse, a Director of Nursing, a police officer, a security guard, or any other suitable person entrusted to collect the items. As used herein, an “item” is intended to refer to any object inserted into the drop body assembly 12 or the shredding assembly 14, and may include medications, medical waste, personally identifiable information, medication documentation, medical documents, or other suitable items. Further as used herein, “medication” is intended to refer to any substance used in treating disease or relieving pain whether in a liquid, solid, or gas state, and includes, but is not limited to, substances contained within a bottle, a dispensing device (such as an inhaler), or an individually packaged item (such as a blister package).

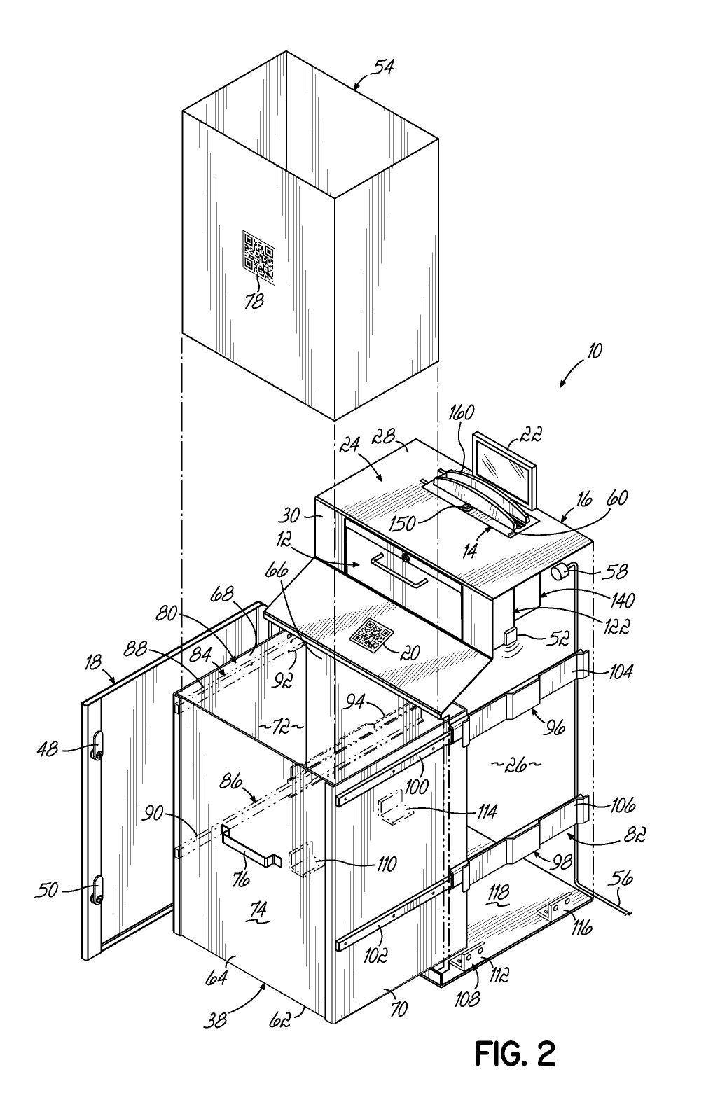

With continued reference to FIGS. 1-4B, the body 16 of the medication collection system 10 has an exterior 24 (shown in FIG. 1) and defines an interior cavity 26 (shown in FIGS. 2-4B). The body 16 includes a top panel 28, a front panel 30, a back panel 32 disposed opposite the front panel 30, a left side panel 34 and a right side panel 36. The left and right side panels 34, 36 are disposed opposite from one another and adjacent the front panel 30 and the back panel 32. As shown, the body 16 is constructed from 14 and 18 gauge steel sheet metal. However, persons skilled in the art would appreciate that other suitable thicknesses and other suitable materials may be used. In the embodiment shown, the contents disposed within the interior cavity 26 of the body 16 are not viewable through the body 16. A graphic (not shown), such as a company logo, company name, or use instructions may be attached to or formed on the exterior 24. According to one exemplary embodiment, a powder coated finish may be applied to the exterior 24.

FIGS. 1-3 show the door 18 being hingably attached to the left side panel 34, but it could alternatively be hingably attached to one of the top panel 28, the front panel 30, the back panel 32, or the right side panel 36 of the body 16 allowing for access to the collection receptacle 38. Specifically, FIG. 1 shows the door 18 being hingably attached to the left side panel 34 using first and second hinges 40, 42. The door 18 may be made from the same or different material and thickness than the body 16. The first and second hinges 40, 42 are security hinges; however, persons skilled in the art would appreciate that other types of suitable doors and suitable hinges may be used. While FIGS. 1-3 show the door 18 having a upper lock 44 and an lower lock 46 to prevent unauthorized access to the interior cavity 26, more or less locks are also envisioned. According to one exemplary embodiment, the upper and lower locks 44, 46 are operated by separate serialized keys (not shown), allowing for easy tracking of the original keys and replacement keys (if applicable). Using separate serialized keys also may require that two authorized key holders be present to open the locks 44, 46, such that no single individual can open the locks 44, 46 by themselves. The upper and lower latch portions 48, 50 of the upper and lower locks 44, 46 latch onto portions of the body 16 to prevent the door 18 from opening when the door 18 is in the locked position. While not shown, various types of locks are also envisioned, such as locks using a keypad, a padlock, a thumb scanner, a retina scan, and other types of suitable locks.

The medication collection system 10 may include a scannable indicia 20 that is unique to the particular medication collection system 10. The scannable indicia 20 indicates the location or other identifying information of the particular medication collection system 10. As used herein, a scannable indicia 20 is intended to refer to any scannable medium, including but not limited to, a one dimensional bar code (such as UPC), a two dimensional bar code (such as a QR code shown in the Figures), a three dimensional bar code, or a radio frequency identification (RFID) indicia. As shown in FIGS. 1 and 2, a scannable indicia 20 is located on the exterior 24 of the body 16 and is configured to be scanned by a user prior to depositing the medication or prior to opening the medication collection system 10 to empty the deposited items. While the scannable indicia 20 shown in the FIGS. 1 and 2 is located on the front panel 30 of the body 16, the scannable indicia 20 may be located on any suitable surface of the exterior 20 of the body 16. The scannable indicia 20 enables a robust method to track deposited items (including medication) and works with various different asset tracking software. The scannable indicia 20 may be scanned using a scanning device (not shown), such as a Smartphone for example, possessed by the user or a scanning device attached to the particular medication collection system 10. While not shown, the display screen 22 may display the scannable indicia 20, such that a separate scannable indicia 20 is not needed on the exterior of the body 16.

As shown in FIG. 2, the medication collection system 10 may include at least one sensor 52 configured to indicate when the collection receptacle 38 or a removable liner 54 needs to be emptied. According to one exemplary embodiment, the sensor 52 may be in the form of a sonic range finder that may also check the density of the material entering the drop box assembly 12 or the shredding assembly 14. It is also envisioned that the at least one sensor 52 may communicate wirelessly with a device (such as a Smartphone or other suitable communication device), sending an alert that the collection receptacle 38 or removable liner 54 (if present) has reached a predetermined fill level. The sensor 52 may be battery powered and/or may receive power from an electrical cord 56 and outlet 58 configured to be connected to various different types of wall outlets (not shown).

As shown in FIGS. 1-3, the medication collection system 10 includes display screen 22. The display screen 22 may display a variety of information to a user or collector. The display screen 22 may be in communication, either wirelessly or in direct electrical connection, with the at least one sensor 52 and be configured to display a message when the collection receptacle 38 needs to be emptied. The display screen 22 may be battery powered and/or may receive power from an electrical cord 56 and outlet 58 configured to be connected to various different types of wall outlets (not shown). Instead of, or in addition to the display screen 22, light emitting diodes 60 may be located on the shredding assembly 14 or the body 16 and be in communication, either wirelessly or in direct electrical connection, with the at least one sensor 52.

As shown in FIG. 2, the collection receptacle 38 is disposed within the interior cavity 26. The collection receptacle 38 includes a bottom portion 62, a front portion 64, a back portion 66 disposed opposite the front portion 64, and left and right side portions 68, 70 disposed opposite one another and adjacent the front and back portions 64, 66, which collectively define an inside 72 and an outside 74 of the collection receptacle 38. A handle 76 may be attached to the outside 74 of the front portion 64 to assist with moving the collection receptacle 38 into and out of the interior cavity 26. The handle 76 may be attached to the collection receptacle 38 or the handle 76 may be formed by an aperture (not shown) in the collection receptacle 38 that is sized to permit one or more fingers of the collector to pull the collection receptacle 38 in and out, allowing for easier access to the collection receptacle 38. In the embodiment shown, the collection receptacle 38 is formed from 32 gauge aluminum that is cleanable and contains spills and leaks. However, persons skilled in the art would appreciate that the collection receptacle 38 may be made from any suitable material of any suitable thickness.

As shown in FIG. 2, removable liner 54 is sized to fit within the collection receptacle 38 to collect the deposited items (including medication). Various sizes of the removable liner 54 may be used such as a five-gallon version, a ten-gallon version, and/or a fifteen-gallon version, for example. The removable liner 54 may be removed from the collection receptacle 38 by the collector when desired. For example, the removable liner 54 may be removed after a certain period of time or when the sensor 52 indicates that the contents of the removable liner 54 have reached a certain predetermined level, and may send a signal to the display screen 22 and/or the light emitting diodes 60 to indicate that the collection receptacle 38 needs to be emptied or the removable liner 54 needs to be replaced. The removable liner 54 may roll over the edge of the collection receptacle 38 or include a closure mechanism (not shown) such as a drawstring, hook-and loop material (such as Velcro®), an elastic band, or other suitable closure mechanism to attach the removable liner 54 to the collection receptacle 38 to prevent the removable liner 54 from moving. The removable liner 54 may include a scannable liner indicia 78 similar to the scannable indicia 20 described above. According to one exemplary embodiment, the scannable liner indicia 78 may be a barcode and may include prepaid postage for shipment to a contracted disposal company of choice, as will be discussed below. The removable liner 54 may also include a tamper evident closure mechanism (not shown) that prevents tampering with the removable liner 54 after removable liner 54 is removed, closed, and sealed.

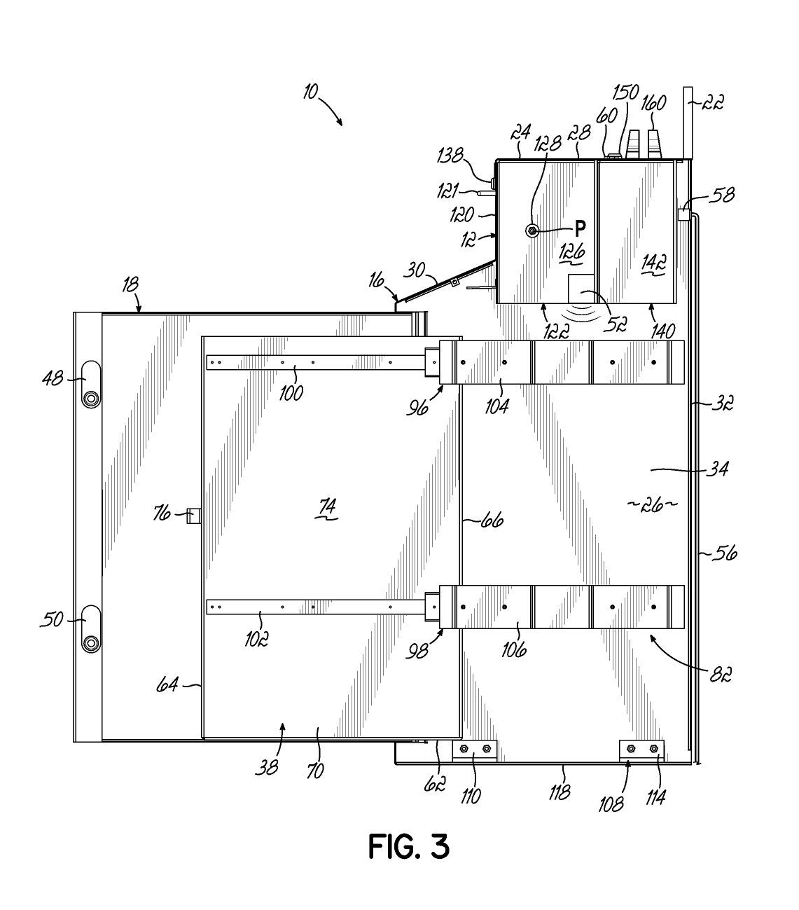

FIGS. 2 and 3 show the medication collection system 10 including a first slideable track 80 attachable to the left side panel 34 of the body 16 and the left side portion 68 of the collection receptacle 38, and a second slideable track 82 attachable to the right side panel 36 of the body 16 and the right side portion 70 of the collection receptacle 38. The first and second slideable tracks 80, 82 enable the collection receptacle 38 to slidably extend from the interior cavity 26 when the door 18 is opened. As shown, the first slideable track 80 may include upper and lower first slideable tracks 84, 86 to aid in the load distribution of the collection receptacle 38 containing the items.

The upper and lower first slideable tracks 84, 86 may include upper and lower slideable track engagement portions 88, 90 that are each attached to the left side portion 68. Likewise, the upper and lower first slideable tracks 84, 86 may also include upper and lower first slideable track receiving portions 92, 94 that are each attached to the left side panel 34. As shown, the upper and lower first slideable track engagement portions 88, 90 engage the respective upper and lower first slideable track receiving portions 92, 94. Similarly, the upper and lower second slideable tracks 96, 98 may include upper and lower second slideable track engagement portions 100, 102 that are each attached to the right side portion 70. Likewise, the upper and lower second slideable tracks 96, 98 may also include upper and lower second slideable track receiving portions 104, 106 that are each attached to the right side panel 36. The upper and lower second slideable track engagement portions 100, 102 engage the respective upper and lower second slideable track receiving portions 104, 106.

With continued reference to FIGS. 2 and 3, the medication collection system 10 includes at least one securing mechanism 108 attached to the body 16 and configured to be attached to a non-movable structure (not shown) to prevent the body 16 from being moved by unauthorized personnel. As used herein, a non-movable structure is intended to include any structure (such as a floor or wall for example) that the securing mechanism 108 may be attached to prevent unauthorized movement of the medication collection system 10. FIGS. 2 and 3 show the at least one securing mechanism 108 in the form of first, second, third, and fourth brackets 110, 112, 114, 116. The first, second, third, and fourth brackets 110, 112, 114, 116 may be attached to at least one of a bottom panel 118 of the body 16, the left side panel 34, or the right side panel 36. As shown, the first, second, third, and fourth brackets 110, 112, 114, 116 are made of steel, however, any suitable material may be used. The at least one securing mechanism 108 may be attached to the body 16 during assembly of the medication collection system 10. Alternatively, the at least one securing mechanism 108 may be attached at a later time.

FIGS. 4A and 4B show further details of the drop box assembly 12. The drop box assembly 12 is disposed above the collection receptacle 38 (FIG. 3) and enables for collection of items contained in bulk containers, including but not limited to, such as liquid medication bottles and medication bottles. The drop box assembly 12 includes a drop box door 120 that is moveable between an open position (FIG. 4A) and a closed position (FIG. 4B) using handle 121. The drop box door 120 pivotally rotates about a pivot point P and may be attached to a drop box container 122 (shown in FIGS. 4A and 4B using dashed lines). The drop box door 120 is attached to drop box container 122 on the left side by a first fastener (not shown in FIGS. 4A and 4B but shown as first fastener 324 in FIG. 7) and on the right side 126 of the drop box container 122 by a second fastener 128. Persons skilled in the art would appreciate that the drop box assembly 12 may move between the open and closed positions using a variety of fastening structures.

In the open position shown in FIG. 4A, the drop box assembly 12 is configured to receive the items from a user. In the open position, a leading edge 129 of the drop box door 120 contacts a back wall 130 of the drop box container 122 to prevent access to the items contained within interior cavity 26, such as medications. Additionally, the drop box assembly 12 may include a stop mechanism 132 that is spaced at a distance from an angled surface 134 of the drop box container 122 when the drop box assembly 12 is in the open position. When the drop box door 120 is moved to the closed position shown in FIG. 4B, the deposited items drop into the collection receptacle 38 (or into the removable liner 54 if in use). In the closed position of FIG. 4B, the stop mechanism 132 may contact the angled surface 134 of the drop box container 122. As shown, the stop mechanism 132 is attached to the drop box container 122 using a fastener 136. In some embodiments, the drop box assembly 12 may be coated with a non-stick material (such as Teflon™, commercially available from the Chemours Company of Wilmington, Del.) to assist the items being inserted into the drop box assembly 12 to readily slide into the collection receptacle 38. The drop box assembly 12 may also include one or more locks 138 to prevent unauthorized access. In some embodiments, unlocking the lock 138 of the drop box assembly 12 may allow or prohibit the shredding assembly 14 from operating.

As shown in FIGS. 5A and 5B, the shredding assembly 14 contains a slot 139 attached to the top panel 28 of the body 16 and may be encased at least partially by a shredding container 140 (FIGS. 4A and 4B, dashed lines). The shredding assembly 14 is capable of shredding items such as: medications (in a variety of packaging configurations such as pills and blister packs) and other items (such as papers and other suitable medical waste). The shredding assembly 14 is configured to shred and then drop the shredded items into the collection receptacle 38 (or into the removable liner 54 if in use). The flow of shredded items into the collection receptacle 38 may be guided by the walls 142 of the shredding container 140. While the shredding assembly 14 shown in the Figures is attached to the top panel 28 of the body 16, the shredding assembly 14 may alternatively be contained within the interior cavity 26 of the body 16. Having the shredding assembly 14 contained completely, or at least partially, within the interior cavity 26, enables all items to be deposited into the drop box assembly 12 as discussed above, and then be shredded using the shredding assembly 14. The shredded items are then dropped into the collection receptacle 38.

The shredding assembly 14 includes a motor 144 powering first and second rotating blades 146, 148. The motor 144 may be battery powered and/or may receive power from an electrical cord 56 and an outlet 58 configured to be connected to various different types of wall outlets (not shown). The first and second rotating blades 146, 148 may be made of any suitable material, and may be self cleaning. Additionally, the first and second rotating blades 146, 148 may be easily removed for cleaning and replacement, if desired or necessary. The shredding assembly 14 may include dust control brushes (not shown) that are configured to reduce dust produced during the shredding process. A lock 150 may be incorporated to secure the shredding assembly 14 to the body 16, and prevent unauthorized removal. As shown in FIGS. 5A and 5B, first and second extension portions 152, 154 may guide the shredding assembly 14 into the appropriate position. As shown in FIG. 5B, the top panel 28 includes first and second receiving portions 156, 158 that are sized to receive the first and second extension portions 152, 154. While not shown, fasteners may attach to the shredding assembly 14 and the interior cavity 26 or the exterior 24 of the body 16. As shown in dashed lines in FIGS. 1-4B, a guard 160 may be attached to the shredding assembly 14 or the body 16 using fasteners to prevent hands or fingers from contacting the first and second rotating blades 146, 148.

With reference to FIGS. 6 and 7, another embodiment of a medication collection system is shown. This medication collection system 210 includes many of the same elements as the previously described embodiment (medication collection system 10), and these elements have been provided with similar reference numbers in the 200 and 300 series where the elements are substantially similar or identical. For example, the medication collection system 210 of this embodiment again includes: a drop box assembly 212, a body 216, a door 218, a scannable indicia 220, an exterior 224, an interior cavity 226, a top panel 228, a front panel 230, a back panel 232, left and right side panels 234, 236, a collection receptacle 238, first and second hinges 240, 242, upper and lower locks 244, 246, upper and lower latch portions 248, 250, at least one sensor 252, a removable liner 254, a bottom portion 262, a front portion 264, a back portion 266, left and right side portions 268, 270, an inside 272, an outside 274, a handle 276, a scannable liner indicia 278, first and second slideable tracks 280, 282, upper and lower first slideable tracks 284, 286, upper and lower first slideable track engagement portions 288, 290, upper and lower first slideable track receiving portions 292, 294, upper and lower second slideable tracks 296, 298, upper and lower second slideable track engagement portions 300, 302, upper and lower second slideable track receiving portions 304, 306, at least one securing mechanism 308, first, second, third, and fourth brackets 310, 312, 314, 316, a bottom panel 318, a drop box door 320, a handle 321, a drop box container 322, a right side 326, a back wall 330, and one or more locks 338. Although these elements may have slightly modified shapes or profiles in this embodiment, the medication collection system 210 and its elements function as described above except where the differences are outlined in further detail below (the detailed description of these identical or substantially similar elements is largely not repeated herein for the sake of brevity).

As shown in FIGS. 6 and 7, without the display screen and the shredder assembly, the medication collection system 210 may function without a power source. As a result, this allows the medication collection system 210 to be located remotely from a power source. Additionally, FIG. 7 shows the drop box assembly 212 in the open position exposing the first fastener 324.

With reference to FIGS. 8 and 9, another embodiment of a medication collection system is shown. This medication collection system 410 includes many of the same elements as the previously described embodiments (medication collection systems 10, 210), and these elements have been provided with similar reference numbers in the 400 and 500 series where the elements are substantially similar or identical. For example, the medication collection system 410 of this embodiment again includes a shredding assembly 414, a body 416, a door 418, a scannable indicia 420, a display screen 422, an exterior 424, an interior cavity 426, a top panel 428, a front panel 430, a back panel 432, left and right side panels 434, 436, a collection receptacle 438, first and second hinges 440, 442, upper and lower locks 444, 446, upper and lower latch portions 448, 450, at least one sensor 452, a removable liner 454, an electrical cord 456, an outlet 458, light emitting diodes 460, a bottom portion 462, a front portion 464, a back portion 466, left and right side portions 468, 470, an inside 472, an outside 474, a handle 476, a scannable liner indicia 478, first and second slideable tracks 480, 482, upper and lower first slideable tracks 484, 486, upper and lower first slideable track engagement portions 488, 490, upper and lower first slideable track receiving portions 492, 494, upper and lower second slideable tracks 496, 498, upper and lower second slideable track engagement portions 500, 502, upper and lower second slideable track receiving portions 504, 506, at least one securing mechanism 508, first, second, third, and fourth brackets 510, 512, 514, 516, a bottom panel 518, a slot 539, a shredding container 540, walls 542, and a lock 550. Although many of these elements may have slightly modified shapes or profiles in this embodiment, the medication collection system 410 and its elements function as described above except where the differences are outlined in further detail below (the detailed description of these identical or substantially similar elements is largely not repeated herein for the sake of brevity).

Because the medication collection system 410 shown in FIGS. 8 and 9 does not include a drop box assembly, the front panel 430 may extend upward and form a cuboid shape. This may allow for the collection receptacle 438 to have an increased capacity. Also, the scannable indicia 420 may be located on the top panel 428 as shown, or may be located on the front panel 430, as previously described.

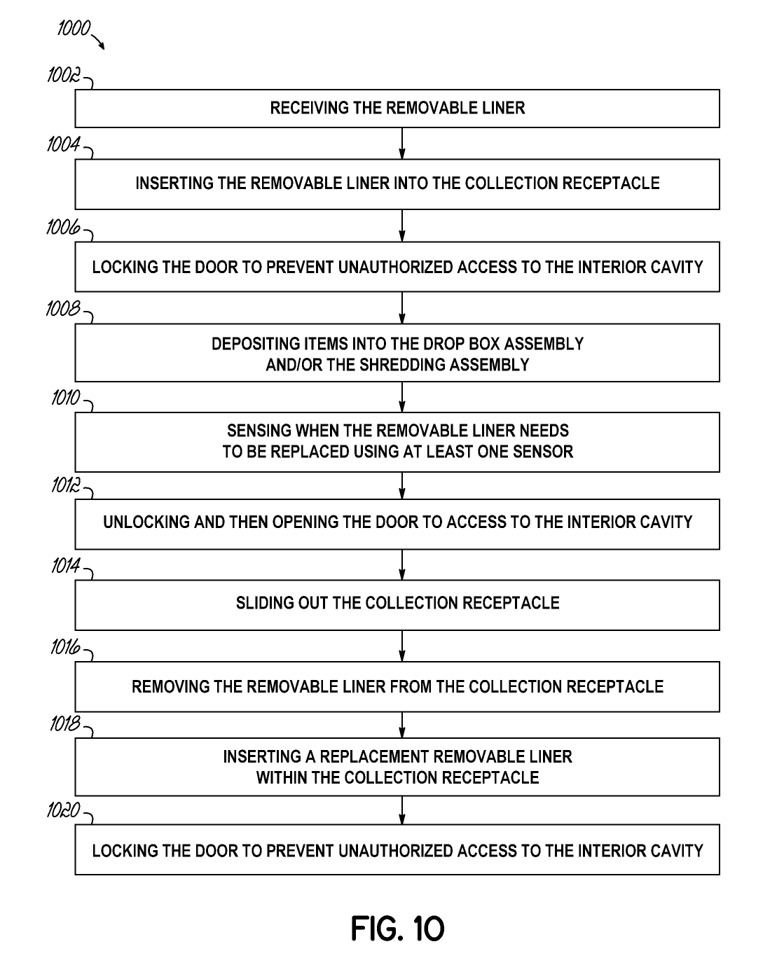

FIG. 10 describes a method 1000 of operating the medication collection system 10, 210, 410 according to the various embodiments. At step 1002, the method includes a supplier shipping one or more removable liners 54, 254, 454 to a customer, which may be the collector. Information used by the supplier may include the name of the customer, the physical address of the location receiving the removable liners 54, 254, 454, the date the removable liners 54, 254, 454 were shipped, the number of removable liners 54, 254, 454 sent with the corresponding unique identification numbers to identify each particular medication collection system 10, 210, 410 or each particular removable liner 54, 254, 454, and/or the size of each removable liner 54, 254, 454 sent. For example, the package of removable liners 54, 254, 454 may be shipped using a shipping company (such as the United Parcel Service) or directly transported by the supplier to the customer, which again may be the collector.

Upon the package arriving to the customer, the customer may record various data including: the date the removable liners 54, 254, 454 were received, a unique identification number specific to each removable liner 54, 254, 454, and/or a signature of one or more witnesses. Recording and optionally witnessing this information ensures greater accuracy, security, and accountability. The removable liner 54, 254, 454 may be assigned to a medication collection system 10, 210, 410 at a particular location, or may be assigned to multiple medication collection systems 10, 210, 410 at different locations.

At step 1004, the removable liner 54, 254, 454 is inserted into the collection receptacle 38, 238, 438. Various data may be recorded, including the date each removable liner 54, 254, 454 was inserted, the address of the location where each removable liner 54, 254, 454 was inserted, the unique identification number and size of each removable liner 54, 254, 454 inserted, the registration number of the collector, and the names and signatures of the two witnesses that witnessed the insertion to ensure accuracy, security, and accountability. A scannable liner indicia 78, 278, 478 may be scanned prior to inserting the removable liner 54, 254, 454 into the collection receptacle 38, 238, 438. To aid in inserting the removable liner 54, 254, 454 into the collection receptacle 38, 238, 438, the collection receptacle 38, 238, 438 may be slid out from the interior cavity 26, 226, 426 using the handle 76, 276, 476, the first slideable track 80, 280, 480 and the second slideable track 82, 282, 482, as described above with respect to the various embodiments.

At step 1006, after inserting the removable liner 54, 254, 454, the door 18, 218, 418 may be closed and then locked to prevent unauthorized access to the interior cavity 26, 226, 426. For example, the door 18, 218, 418 may be locked using the upper lock 44, 244, 444 and the lower lock 46, 246, 446.

At step 1008, in embodiments including a drop box assembly 12, 212, items (including medication) may be received when the drop box door 120, 320 is in the open position. The items are then directed into the removable liner 54, 254 when the drop box door 120, 320 is moved to the closed position (as shown in FIGS. 4A and 4B). In embodiments including a shredding assembly 14, 414, items (including medications) to be shredded may be inserted into the shredding assembly 14, 414 and shredded. The then shredded items drop into the removable liner 54, 454. Prior to, or after inserting the items into at least one of the drop box assembly 12, 212 or the shredding assembly 14, 414, the user may scan a scannable indicia 20, 220, 420 disposed on the exterior 24, 224, 424 of the body 16, 216, 416 to log the items deposited into the medication collection system 10, 210, 410.

At step 1010, at least one sensor 52, 252, 452 senses when the removable liner 54, 254, 454 needs to be replaced as discussed above. After sensing the removable liner 54, 254, 454 needs to be replaced, a message may be displayed on the display screen 22, 422 that is in communication with the at least one sensor 52, 252, 452 to alert a collector that the removable liner 54, 254, 454 needs to be replaced. In addition to, or instead of a message being displayed on the display screen 22, 422, the light emitting diodes 60, 460 may be illuminated.

At step 1012, upon sensing that the removable liner 54, 254, 454 should be replaced, the door 18, 218, 418 may be unlocked and then opened to access to the interior cavity 26, 226, 426. For example, the door 18, 218, 418 may be unlocked using the upper lock 44, 244, 444 and the lower lock 46, 246, 446.

At step 1014, to aid in inserting the removable liner 54, 254, 454 into the collection receptacle 38, 238, 438, the collection receptacle 38, 238, 438 may be slid out from the interior cavity 26, 226, 426 using the first slideable track 80, 280, 480 and the second slideable track 82, 282, 482, as described above with respect to the various embodiments.

At step 1016, the removable liner 54, 254, 454 may be removed from the collection receptacle 38, 238, 438. After removing the removable liner 54, 254, 454 from the collection receptacle 38, 238, 438, the removable liner 54, 254, 454 may be securely closed to prevent unauthorized access to the items within the removable liner 54, 254, 454. Before or after securely closing the removable liner 54, 254, 454, various data may be recorded including at least one of: a date the removable liner 54, 254, 454 was securely closed, a unique identification number specific to the removable liner 54, 254, 454, the address of the location where each removable liner 54, 254, 454 was removed, the size of each removable liner 54, 254, 454 removed, the registration number of the collector, and the names and signatures of the two witnesses that witnessed the removal to ensure accuracy, security, and accountability.

At step 1018, the collector inserts a replacement removable liner 54, 254, 454 within the collection receptacle 38, 238, 438. The collector may scan the scannable liner indicia 78, 278, 478 disposed on the removable liner 54, 254, 454 before or after inserting the removable liner 54, 254, 454 into the collection receptacle 38, 238, 438. Then, at step 1020, the collector locks the door 18, 218, 418 to prevent unauthorized access to the interior cavity 26, 226, 426.

The removable liner 54, 254, 454 may remain at the location (for example, a pharmacy, hospital, or long term care facility) until sufficient removable liners 54, 254, 454 accumulate to ship the removable liners 54, 254, 454 as a group. If stored, various data may also be recorded including, the date each sealed removable liner 54, 254, 454 is transferred to storage, the unique identification number and size of each sealed removable liner 54, 254, 454 stored, and the names and signatures of the two witnesses that transferred each sealed removable liner 54, 254, 454 to storage. Alternatively, the removable liner 54, 254, 454 may be immediately shipped to a destruction facility or other suitable location.

Regarding destruction or disposal, various data may be recorded including the date each removable liner 54, 254, 454 is transferred for destruction, the address and registration number of the reverse distributor or distributor to whom each removable liner 54, 254, 454 was transferred, the unique identification number and the size of each removable liner 54, 254, 454 transferred, and the names and signatures of the two witnesses that transferred each removable liner 54, 254, 454 to the reverse distributor or distributor.

While the present invention has been illustrated by a description of exemplary embodiments and while these embodiments have been described in some detail, it is not the intention of the Applicant to restrict or in any way limit the scope of the appended claims to such detail. Additional advantages and modifications will readily appear to those skilled in the art. The various features of the disclosure may be used alone or in any combination depending on the needs and preferences of the user. This has been a description of the present invention, along with the preferred methods of practicing the present invention as currently known. However, the invention itself should only be defined by the appended claims.

What is claimed is:

1. A medication collection system comprising:
a body having an exterior and defining an interior cavity, the body including at least a top panel, a front panel, a back panel disposed opposite the front panel, and left and right side panels disposed opposite one another and adjacent the front and back panels;
a collection receptacle disposed within the interior cavity;
a door hingably attached to one of the panels of the body for allowing access to the collection receptacle;
a drop box assembly attached to the body and disposed above the collection receptacle, the drop box assembly having a door moveable between an open position and a closed position, wherein the drop box assembly is configured to receive items when the door is in the open position and drop the items into the collection receptacle when the door is moved to the closed position;
a scannable indicia disposed on the exterior of the body and configured to be scanned by a user; and
at least one securing mechanism attached to the body and configured to be attached to a non-movable structure to prevent the body from being moved.

2. The medication collection system of claim 1 further comprising:
a shredding assembly attached to the top panel of the body and configured to shred items and then drop the shredded items into the collection receptacle.

3. The medication collection system of claim 1 further comprising:
a removable liner configured to be placed within the collection receptacle to collect the items and be removed from the collection receptacle when desired.

4. The medication collection system of claim 1 further comprising:
a first slideable track attachable to the left side panel and the collection receptacle; and
a second slideable track attachable to the right side panel and the collection receptacle,
whereby the first and second slideable tracks enable the collection receptacle to slidably move out of the interior cavity when the door is opened.

5. The medication collection system of claim 4:
wherein the first slideable track comprises upper and lower left slideable tracks, each being attachable to the left side panel and the collection receptacle, and
wherein the second slideable track comprises upper and lower right slideable tracks, each being attachable to the right side panel and the collection receptacle.

6. The medication collection system of claim 4, wherein the collection receptacle further includes a handle to assist with slidably moving the collection receptacle out of the interior cavity.

7. The medication collection system of claim 1:
wherein the body further includes a bottom panel, and
wherein the at least one securing mechanism further includes at least first and second brackets, each being attached to at least one of the bottom panel, the left side panel, or the right side panel.

8. The medication collection system of claim 1, wherein the door further includes at least one lock configured to prevent unauthorized access to the interior cavity.

9. The medication collection system of claim 1 further comprising:
at least one sensor configured to indicate when the collection receptacle needs to be emptied.

10. The medication collection system of claim 9 further comprising:
a display screen in communication with the at least one sensor and configured to display a message when the collection receptacle needs to be emptied.

11. A medication collection system comprising:
a body having an exterior and defining an interior cavity, the body including at least a top panel, a front panel, a back panel disposed opposite the front panel, and left and right side panels disposed opposite one another and adjacent the front and back panels;
a collection receptacle disposed within the interior cavity;
a door hingably attached to one of the panels of the body for allowing access to the collection receptacle;
a drop box assembly attached to the body and disposed above the collection receptacle, the drop box assembly having a door moveable between an open position and a closed position, wherein the drop box assembly is configured to receive items when the door is in the open position and direct the items into the collection receptacle when the door is moved to the closed position;
a shredding assembly disposed adjacent the top panel of the body and configured to shred items and then drop the shredded items into the collection receptacle;
at least one securing mechanism attached to the body and configured to be attached to a non-movable structure to prevent the body from being moved;
at least one sensor configured to indicate when the collection receptacle needs to be emptied;
a display screen in communication with the at least one sensor and configured to display a message when the collection receptacle needs to be emptied;
a first slideable track attachable to the left side panel and the collection receptacle; and
a second slideable track attachable to the right side panel and the collection receptacle,
whereby the first and second slideable tracks enable the collection receptacle to slidably move out of the interior cavity when the door is opened.

12. The medication collection system of claim 11 further comprising:
a removable liner configured to be placed within the collection receptacle to collect the items.

13. The medication collection system of claim 11 further comprising:
a scannable indicia disposed on the exterior of the body and configured to be scanned by a user.

14. The medication collection system of claim 11:
wherein the first slideable track comprises upper and lower left slideable tracks, each being attachable to the left side panel and the collection receptacle, and
wherein the second slideable track comprises upper and lower right slideable tracks, each being attachable to the right side panel and the collection receptacle.

15. A method of operating a medication collection system including a body having an exterior and defining an interior cavity, the body including at least a top panel, a front panel, a back panel disposed opposite the front panel, and left and right side panels disposed opposite one another and adjacent the front and back panels, a collection receptacle slidably disposed within the interior cavity, a removable liner placed within the collection receptacle to collect items, and a door hingably attached to one of the panels of the body for allowing access to the collection receptacle, the method comprising:
sensing when the removable liner needs to be replaced using at least one sensor;
unlocking and then opening the door to access to the interior cavity;
sliding out the collection receptacle;
removing the removable liner from the collection receptacle;
inserting a replacement removable liner within the collection receptacle; and
locking the door to prevent unauthorized access to the interior cavity.

16. The method of claim 15, wherein prior to sensing when the removable liner needs to be replaced, the method further comprises:
receiving the removable liner from a supplier;
recording at least one of: a date the removable liner was received, a unique identification number specific to the removable liner, or a signature of a witness;
inserting the removable liner within the collection receptacle; and
locking the door to prevent unauthorized access to the interior cavity.

17. The method of claim 16, wherein prior to locking the door, the method further comprises:
scanning a scannable indicia disposed on the removable liner.

18. The method of claim 15, wherein the medication collection system further includes a drop box assembly attached to the body and disposed above the collection receptacle, the drop box assembly having a door moveable between an open position and a closed position, wherein prior to sensing when the removable liner needs to be replaced, the method further comprises:
receiving the items when the door is in an open position; and
directing the items into the removable liner when the door is moved to the closed position.

19. The method of claim 15, wherein the medication collection system further includes a shredding assembly disposed adjacent the top panel of the body, wherein prior to sensing when the removable liner needs to be replaced, the method further comprises:
shredding the items inserted into the shredding assembly; and
dropping the now shredded items into the removable liner.

20. The method of claim 15 further comprising:
scanning a scannable indicia disposed on the exterior of the body.

21. The method of claim 15 further comprising:
after removing the removable liner from the collection receptacle, securely closing the removable liner to prevent unauthorized access to the items in the removable liner; and
after securely closing the removable liner, recording at least one of: a date the removable liner was securely closed, a unique identification number specific to the removable liner, or a signature of a witness.

22. The method of claim 15, wherein after sensing the removable liner needs to be replaced, displaying a message on a display screen that is in communication with the at least one sensor to indicate that the removable liner needs to be replaced.

23. The method of claim 15 further comprising:
securing the body to a non-movable structure using at least first and second brackets, each being attached to at least one of the bottom panel, the left side panel and/or the right side panel.

24. A method of disposing items into a medication collection system including a body having an exterior and an interior cavity, a drop box assembly attached to the body and having a door moveable between an open position and a closed position, the method comprising:
logging the items to be inserted into the drop box assembly;
scanning a scannable indicia disposed on the exterior of the body;
inserting the items when the door is in the open position; and
moving the door to the closed position to transfer the inserted items into the interior cavity.

25. The method of claim 24, wherein the medication collection system further includes a shredding assembly formed in the body and at least partially surrounded by a guard configured to prevent injury, the method further comprises:
inserting the items to be shredded into the shredding assembly.
